(19) United States
(12) Patent Application Publication
(10) Pub. No.: US 2020/0175547 A1
(43) Pub. Date: Jun. 4, 2020

(54) PROMOTIONAL VIDEO PRODUCTION LINKAGE SYSTEM FOR SALES PRODUCTS CLASSIFIED BY COUNTRIES

(71) Applicant: CREFUN CO.,LTD., Mokpo-si (KR)

(72) Inventors: Ji Woong LEE, Jeollanam-do (KR); Bo Hyung LEE, Jeollanam-do (KR); Sung Hyun PARK, Mokpo-si (KR)

(73) Assignee: CREFUN CO., LTD., Mokpo-si (KR)

(21) Appl. No.: 16/226,962

(22) Filed: Dec. 20, 2018

(30) Foreign Application Priority Data
Nov. 30, 2018 (KR) 10-2018-0152601

(51) Int. Cl. G06Q 30/02; G06F 16/28

(52) U.S. Cl. CPC G06Q 30/0254; G06Q 30/0276; G06F 16/285

(57) ABSTRACT

Disclosed is a promotional video production linkage system for sales products classified by countries, which grasps the production intention of a promotional video of a product seller requesting the promotional video of a product to be sold in another country, guides contents producers to produce the promotional video at a time according to the intention, and guides the contents producers to produce the promotional video reflected with the culture and the customs of the corresponding country to be sold while meeting the intention of the product seller at a shorter time by guiding only contents creators belonging to the country to sell the corresponding product so as to maximally reflect the culture and customs of the country to sell the corresponding product.

### TECHNICAL FIELD

The present invention relates to a promotional video production linkage system for sales products classified by countries, which grasps the production intention of a promotional video of a product seller requesting the promotional video of a product to be sold in another country, guides contents producers to produce the promotional video at a time, and guides the contents producers to produce the promotional video reflected with the culture and the customs of the corresponding country to be sold while meeting the intention of the product seller at a shorter time by guiding only contents creators belonging to the country to sell the corresponding product so as to maximally reflect the culture and customs of the country to sell the corresponding product.

### BACKGROUND ART

In recent years, the hallyu boom has begun with the export of TV dramas “Winter Sonata” and “Dae Jang Geum” produced by Korea.

Due to this hallyu boom, media contents such as drama have not only improved the recognition of Korea internationally but also made a big market in Korea through international competitiveness.

Particularly, it is intended that many kinds of goods such as clothes, food, ornaments, interior and accessories exposed to the drama, movie or music video, which is the leading role of the hallyu, are increasingly recognized.

Thus, in order to export their products to foreign countries, merchandise sellers of their own country have been required to produce promotional videos in accordance with the culture and customs of the corresponding country.

However, there are problems in that it is not easy for the product sellers to find a large number of contents producers who are active in foreign countries, and even if the product sellers find many content producers who are active in the foreign countries, it is practically difficult for the product sellers to select a content producer capable of customizing the promotional video to which their intentions are maximally reflected, and a lot of time is also required.

### PRIOR ART DOCUMENT

Patent Document

(Patent Document 0001) KR 10-2009-0085938 A

### DISCLOSURE

### Technical Problem

In order to solve the problems in the related art, an object of the present invention is to a promotional video production linkage system for sales products classified by countries, which grasps the production intention of a promotional video of a product seller requesting the promotional video of a product to be sold in another country, guides contents producers to produce the promotional video at a time, and guides the contents producers to produce the promotional video reflected with the culture and the customs of the corresponding country to be sold while meeting the intention of the product seller at a shorter time by guiding only contents creators belonging to the country to sell the corresponding product so as to maximally reflect the culture and customs of the country to sell the corresponding product.

### Technical Solution

An aspect of the present invention provides a promotional video production linkage system for sales products classified by countries comprising: a product seller-side terminal which uploads a global product sales history signal including product sales entry country name information indicating the selling country of the product to be sold and product sales history information as contents related to the sales of the product to be sold; country-classified contents creator-side terminals which are classified by countries and produces creator-side product promotional video information which is a promotional video of the corresponding product produced based on product sales history information of a product requested from another country; and a global promotional video linkage server which includes a promotional video linkage engine which stores and manages a global product sales history signal uploaded from the product seller-side terminal in a seller-specific global product sales history information DB,

wherein the promotional video linkage engine of the global promotional video linkage server transmits a global video production inquiry history signal inquiring whether to produce the global promotional video to the language of the corresponding country corresponding to the product sales entry country name information to the product seller-side terminal when there is no promotional information in the product sales history information of the product sales entry country name information and the product sales history information included in the uploaded global product sales history signal, the product seller-side terminal receives the global video production inquiry history signal, accepts the global promotional video production by the product seller based on the transmitted global video production inquiry history signal, and transmits the global video production request product history signal including an option requested by the product seller at the time of producing the global promotional video as the input information to the global promotional video linkage server, the global promotional video linkage server selects country-classified contents creator-side terminal of the corresponding country belonging to the product sales entry country among the country-classified contents creator-side terminals classified by countries by referring to the product sales entry country name information in the information included in the global product sales history signal with reference to the transmitted global video production inquiry history signal and relay-transmits the global video production request product history signal to the selected country-classified contents creator-side terminals of the corresponding country, the country-classified contents creator-side terminals of the corresponding country receiving the global video production request product history signal transmit designated-country promotional video production related requirement history signals including the history interposed with the requirements of the contents creator of the corresponding country to the global promotional video linkage server, in response to the option required by the product seller included in the global video production request product history, the promotional video linkage engine of the global promotional video linkage server guides the transmitted designated-country promotional video production related requirement history signals to the product seller-side terminal, the product seller-side terminal notifies the corresponding country-classified contents creator-side terminal selected from the country-classified contents creator-side terminals proposing the designated-country promotional video production related requirement history signals to the global promotional video linkage server, the promotional video linkage engine of the global promotional video linkage server recognizes the corresponding country-classified contents creator-side terminal notified from the product seller-side terminal and notifies the request of the promotional video to the recognized corresponding country-classified contents creator-side terminals, the country-classified contents creator-side terminal transmits to the global promotional video linkage server country-specific designated creator-side product promotional video information which is a global promotional video of the corresponding product produced by the request of the global promotional video notified from the global promotional video linkage server, and the promotional video linkage engine of the global promotional video linkage server exposes the country-specific designated creator-side product promotional video information transmitted from the corresponding country-classified contents creator-side terminals and the product sales history information of the corresponding product to the internet shopping malls.

The global promotional video linkage server includes a translation engine; and the global promotional video linkage server operates the translation engine to control the product sales history information of the corresponding product to be exposed to the internet shopping mall to be exposed while being translated to a language of the sales country of the product to be sold.

The promotional video production linkage system for sales products classified by countries may further include a global video production request product purchase option guide screen which includes a basic item display column which displays basic requirement items required basically when producing the promotional video and includes a price as producing cost of the promotional video, a promotional period representing the number of promotional days of the promotional video to be produced, and a profit distribution ratio representing a ratio of distributing a profit generated through showing of the promotional video to a contents creator as information output from the product seller-side terminal accepting the production of the global promotional video based on the transmitted global video production inquiry history signal; and a seller requirement value display column displaying the requirement value of the product seller corresponding to each requirement item displayed in the basic item display column.

The global promotional video linkage server includes a DB unit, the DB unit includes a country-classified sales type-specific promotional video-related trendy keyword DB in which a product list to be sold in the shopping mall is classified by countries, a product list classified by counties is stored and managed for each category of sales types again, and a sales type-specific trendy keyword which is extracted through data mining from web pages interposed in a promotional video in which a language of the promotional video related with the product list belonging to the sales type by the corresponding category is output to a language of the corresponding country is stored and managed for each sales type by category; and the promotional video linkage engine of the global promotional video linkage server extracts country-classified sales type-specific trendy keyword information related with the corresponding product among sales types belonging to the sales entry country of the corresponding product by matching the product corresponding to the global video production request product history with the country-classified sales type-specific promotional video-related trendy keyword DB and transmits the extracted country-classified sales type-specific trendy keyword information related with the corresponding product to the product seller-side terminal, and the product seller-side terminal controls to output the transmitted country-classified sales type-specific trendy keyword information and display the country-classified sales type-specific trendy keyword information selected from the output country-classified sales type-specific trendy keyword information in the additional item display column.

The global promotional video linkage server includes a product video search engine, and the global promotional video linkage server controls to search and collect whether a moving video related with the product corresponding to the global video production request product history is present in the web page including blogs, cafes, and SNS on the internet using the language of the corresponding country to sell the product by operating the product video search engine when the product corresponding to the global video production request product history has no sales type by category belonging to the corresponding country to sell the product in the country-classified sales type-specific promotional video-related trendy keyword DB, extract a country-classified sales type-specific trendy keyword which is a keyword interposed equally in the web pages collected through data mining, and transmit the extracted country-classified sales type-specific trendy keyword to the product seller-side terminal while being translated to the language of the product seller operating the corresponding product seller-side terminal by operating the translation engine.

The promotional video linkage engine of the global promotional video linkage server counts the viewing number when the customer-side terminal accessing the internet shopping mall views the country-specific designated creator-side product promotional video information interposed in the internet shopping mall and accumulatively stores promotional product exposure number information which is the viewing number of the counted country-specific designated creator-side product promotional video information in the country-classified creator-specific promotional video production history information DB.

### Advantageous Effects

According to the present invention, it is possible to grasp the production intention of a promotional video of a product seller requesting the promotional video of a product to be sold in another country, guide contents producers to produce the promotional video at a time, and guide the contents producers to produce the promotional video reflected with the culture and the customs of the corresponding country to be sold while meeting the intention of the product seller at a shorter time by guiding only contents creators belonging to the country to sell the corresponding product so as to maximally reflect the culture and customs of the country to sell the corresponding product.

Further, it is possible to propose various fashion trends related to a promotional video of the corresponding product to be sold to another country by a product seller who requests the promotional video of the product, but it is also possible to guide the product seller to produce the promotional video optimized for trends in each country, which is popular in the corresponding country to be sold.

### DESCRIPTION OF DRAWINGS

FIG. 1 is an overall configuration diagram illustrating a promotional video production linkage system for sales products classified by countries of the present invention.

FIG. 2 is a detailed block configuration diagram illustrating a global promotional video linkage server of constituent elements of the promotional video production linkage system for sales products classified by countries of the present invention.

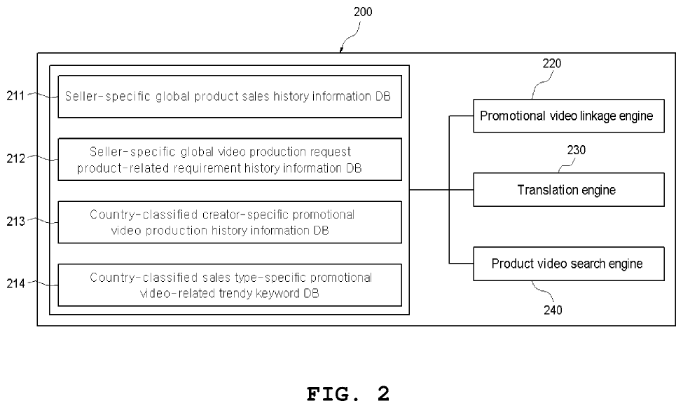

FIG. 3 is a diagram illustrating a guide screen for a global video production request product purchase option, as a screen output to a product seller-side terminal.

FIG. 4 is a diagram illustrating a suggestion screen corresponding to purchasing of a global video production requesting product, as a screen output to a country-classified contents creator-side terminal.

FIG. 5 is a diagram illustrating a country-classified creator list screen as a screen output to the product seller-side terminal.

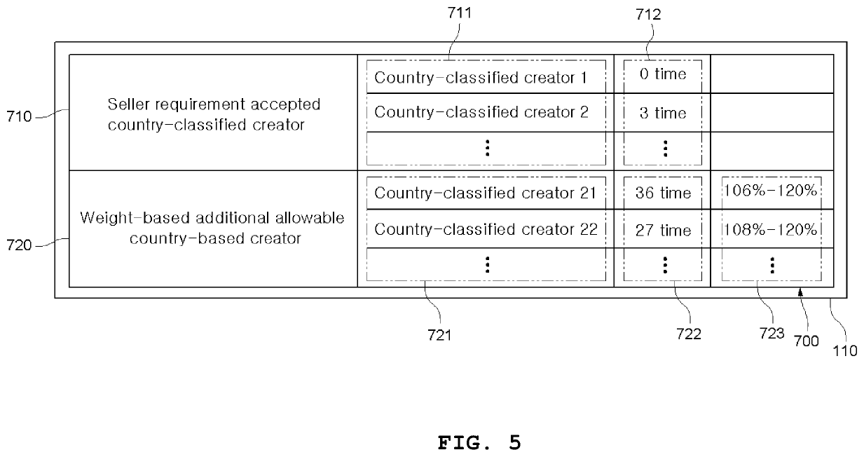

### MODES OF THE INVENTION

Before describing the configuration and operation of an embodiment of the present invention in detail with reference to the accompanying drawings, it will be understood that the present invention may be variously modified and have various forms, and the following embodiments are just mentioned to describe the present invention in detail, but the present invention is not limited to specific illustrative forms, and includes all modifications, equivalents, and alternatives included in the spirit and the scope of the present invention.

In the drawings, the components are expressed to be exaggerated or simplified in sizes or thicknesses in consideration of the convenience of understanding and the like. However, the protection scope of the present invention should not be construed to be limited thereto, and in the case of performing the same function, the same reference numerals will be used as much as possible.

In addition, terms used in the present invention are just used to describe a specific exemplary embodiment and do not intend to limit the present invention and a singular expression may include a plural expression as long as it is not apparently contextually different.

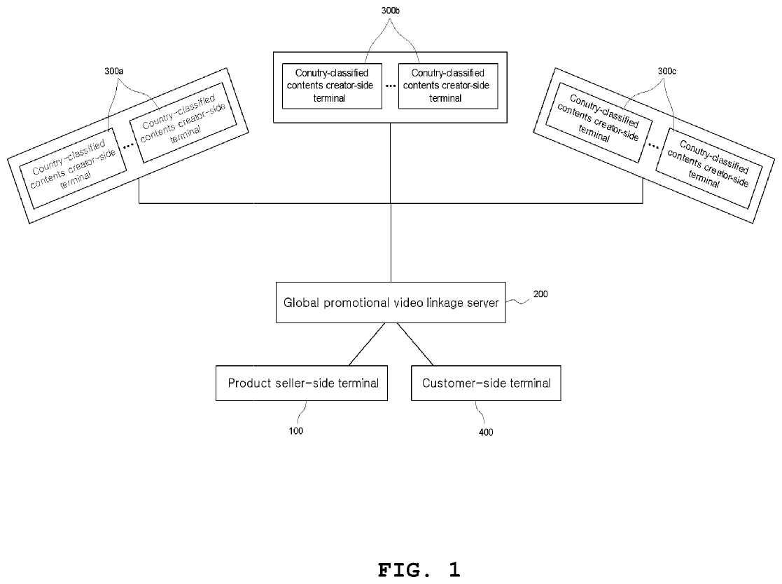

As illustrated in FIG. 1, a promotional video production linkage system for sales products classified by countries of the present invention includes a product seller-side terminal 100, a plurality of country-classified contents creator-side terminals 300, a global promotional video linkage server 200, and a customer-side terminal 400.

First, the product seller-side terminal 100 is a terminal member which requests product sales to all countries of the world by uploading a global product sales history signal including product sales entry country name information indicating the selling country of the product to be sold and product sales history information as contents related to the sale of the product to be sold to the global promotional video linkage server 200.

The product seller-side terminal 100 performing the functions described above may be selectively applied with various wired/wireless terminals such as a personal computer (++PC) or palmtops with a display unit 110, personal digital assistants (PDAs), communication terminal devices such as a smart phone accessible with internet, a portable multimedia player (PMP), or a ultra-mobile PC (UMPC), and a mobile internet device (MID).

Meanwhile, in the case of the display unit 110, various output members, such as a liquid crystal display (LCD), a thin film transistor liquid crystal display (TFT LCD), an organic light emitting diode (OLED), a flexible display, and a 3D display, may be selectively applied.

The plurality of country-classified contents creator-side terminals 300 are classified by countries, and are terminal members for producing creator-side product promotional video information which is a promotional video of the corresponding product produced based on product sales history information of a product requested from another country.

The country-classified contents creator-side terminals 300a, 300b, and 300c performing the functions described above may be selectively applied with various wired/wireless terminals, such as a personal computer (++PC) or palmtops such as the product seller-side terminal 100, personal digital assistants (PDAs), communication terminal devices such as a smart phone accessible with internet, a portable multimedia player (PMP), or a ultra-mobile PC (UMPC), and a mobile internet device (MID).

The global promotional video linkage server 200 is a server member which grasps an intention of producing the promotional video of a product seller requesting a global promotional video of a product, produces a global promotional video according to the intention of the product seller, and guides country-based contents producers of a country assigned by the product seller at a time.

The detailed configuration of the global promotional video linkage server 200 for performing such functions includes a DB unit 210, a promotional video linkage engine 220, a translation engine 230, and a product video search engine 240.

First, the DB unit 210 is a member which stores and manages various kinds of databases required to grasp an intention of producing the promotional video of the product seller requesting the global promotional video of the product, produce the global promotional video according to the intention of the product seller, and guide the country-based contents producers of a country assigned by the product seller at a time.

The DB unit 210 that performs such functions includes a seller-specific global product sales history information DB 211, a seller-specific global video production request product-related requirement history information DB 212, a country-classified creator-specific promotional video production history information DB 213, and a country-classified sales type-specific promotional video-related trendy keyword DB 214.

First, the seller-specific global product sales history information DB 211 is a database member which stores and manages for each member information registered when the product seller joins to be a member, which includes personal information of the product seller including a member's ID, a password, a telephone including a mobile communication terminal, and an address, product sales entry country name information representing sales countries of the product to be sold, and product sales history information which is contents related with the sales of the product to be sold.

The seller-specific global video production request product-related requirement history information DB 212 is a database member which stores and manages for each member information displayed on a global video production request product purchase option guide screen 500 to be described below, which includes contents of each basic requirement item displayed in a basic item display column 510, contents of each additional requirement item displayed in an additional item display column 520, contents of each basic requirement item, a requirement value of the product seller corresponding to the content of each additional requirement item, an additional allowable value which is additionally allowed as compared with a seller requirement value of the seller, and contents of a weight requirement item which is the corresponding requirement item displayed in a weight display column 550.

The country-classified creator-specific promotional video production history information DB 213 is a database which is stored and managed by countries, and a database member, which stores and manages information registered when a country-classified contents creator joins to a member, which includes personal information of the country-classified contents creator including a member's ID, a password, a telephone including a mobile communication terminal, and an address, country-specific assigned creator-side product promotional video information which is a promotional video produced by the corresponding country-classified contents creator, and promotional product exposure number information representing an exposure number of the corresponding country-specific assigned creator-side product promotional video information exposed through internet shopping malls.

The country-classified sales type-specific promotional video-related trendy keyword DB 214 is a database member which is classified by countries, stores and manages a product list classified by counties for each category of sales types again, and is a database member which stores and manages for each sales type by category a sales type-specific trendy keyword which is extracted through data mining from web pages interposed in a promotional video in which a language of the promotional video related with the product list belonging to the sales type by the corresponding category is output to a language of the corresponding country.

The promotional video linkage engine 220 is a member operated by the global promotional video linkage server 200 and a module which controls to grasp an intention of producing the promotional video of the product seller requesting the promotional video of the product to be sold in other countries, produce the global promotional video according to the intention of the product seller, guide contents producers to produce the promotional video according to the intention at a time, and guide only country-based contents creators belonging to the countries to sell the corresponding product so as to maximally reflect the culture and customs of the countries to sell the corresponding product.

The product video search engine 240 is a member operated by the global promotional video linkage server 200 and a module which controls to search and collect whether a moving video related with the product corresponding to the global video production request product history is present in the web page including blogs, cafes, and SNS on the internet using the language of the corresponding country to sell the product by operating the product video search engine 240 when the product corresponding to the global video production request product history has no sales type by category belonging to the corresponding country to sell the product in the country-classified sales type-specific promotional video-related trendy keyword DB 214, extract a country-classified sales type-specific trendy keyword which is a keyword interposed equally in the web pages collected through data mining, and transmit the extracted country-classified sales type-specific trendy keyword to the product seller-side terminal 100.

The translation engine 230 is a translation module which guides to translate the extracted country-classified sales type-specific trendy keyword into the language of the product seller operating the corresponding product seller-side terminal 100 to recognize the product seller operating the corresponding product seller-side terminal 100.

Meanwhile, the product video search engine 240 of the global promotional video linkage server 200 performs functions of controlling to store and manage the country-classified sales type-specific trendy keyword extracted through the data mining by counties in the country-classified sales type-specific promotional video-related trendy keyword DB 214, establish category-specific sales types of the product related with the corresponding country-classified sales type-specific trendy keyword, and store and manage the established category-specific sales types together with the product names.

Further, the product video search engine 240 of the global promotional video linkage server 200 collects the country-classified sales type-specific trendy keyword together with the URL of the web pages of the collected place and guides the corresponding trendy keyword to be output by linking when the product seller clicks the corresponding trendy keyword to provide the corresponding trendy keyword to help in producing the global promotional video of the product seller.

Meanwhile, the promotional video linkage engine 220 of the global promotional video linkage server 200 confirms whether there is the seller-side product promotional video information as the promotional video of the corresponding product to the corresponding product seller-side terminal 100 when the product sales history information uploaded from the product seller-side terminal 100 is information made of texts to upload additionally the seller-side product promotional video information if there is the seller-side product promotional video information, and stores the uploaded product sales history information, product sales entry country name information, and seller-side product promotional video information in the seller-specific global product sales history information DB 211.

Thereafter, the promotional video linkage engine 220 of the global promotional video linkage server 200 exposes product sales history information and seller-side product promotional video information of the corresponding product stored and managed in the seller-specific global product sales history information DB 211 to the internet shopping mall to be used as the promotional video when selling the product.

At this time, the global promotional video linkage server 200 operates the translation engine 230 to perform a function of controlling the product sales history information of the corresponding product to be exposed while being translated to a language used in the product sales entry country designated by the product seller.

In addition, the promotional video linkage engine 220 of the global promotional video linkage server 200 transmits a global video production inquiry history signal inquiring whether to produce the global promotional video to the language of the corresponding country corresponding to the product sales entry country name information to the product seller-side terminal 100 when there is no promotional information in the product sales history information of the product sales entry country name information and the product sales history information included in the uploaded global product sales history signal.

At this time, when it is notified that the production of the promotional video is not desired by referring to the global video production inquiry history signal transmitted from the product seller-side terminal 100, the promotional video linkage engine 220 of the global promotional video linkage server 200 exposes only the product sales history information of the corresponding product as the text information stored and managed in the seller-specific global product sales history information DB 211 to the internal shopping mall.

Even at this time, the promotional video linkage server 200 operates the translation engine 230 to perform a function of controlling the product sales history information of the corresponding product to be exposed to the internet shopping mall while being translated to a language used in the product sales entry country designated by the product seller.

In addition, the product seller-side terminal 100 receives the global video production inquiry history signal, accepts the global promotional video production by the product seller based on the transmitted global video production inquiry history signal, and transmits the global video production request product history signal including an option requested by the product seller at the time of producing the global promotional video as the input information to the global promotional video linkage server 200.

Here, on the display unit 110 of the product seller-side terminal 100 that has accepted the production of the promotional video based on the transmitted video production inquiry history signal, the global video production request product purchase option guide screen 500 is outputted, and performs a function of guiding the product seller included in the aforementioned global video production request product history signal to create various information required when producing the promotional video.

The global video production request product purchase option guide screen 500 performing such a function is provided from the product seller-side terminal 100 when a dedicated application required for requesting the production of the promotional video is installed in the product seller-side terminal 100, and when the product seller-side terminal 100 accesses the global promotional video linkage server 200 to request the production of the promotional video, the dedicated application may be provided from the global promotional video linkage server 200.

The detailed configuration of the global video production request product purchase option guide screen 500 includes a basic item display column 510 which displays basic requirement items required basically when producing the promotional video and includes a price as producing cost of the promotional video, a promotional period representing the number of promotional days of the promotional video to be produced, and a profit distribution ratio representing a ratio of distributing a profit generated through showing of the promotional video to a contents creator, an additional item display column 520 displaying additional requirement items required additionally by the product seller when producing the promotional video, a seller requirement value display column 530 displaying the requirement value of the product seller corresponding to each requirement item displayed in the basic item display column 510 and the additional item display column 520, an additional allowable value display column 540 displaying an allowable value additionally allowed by setting the requirement value displayed on the seller requirement value display column 530 as 100 as information input by the request of the product seller among the respective requirement items displayed on the seller requirement value display column 530, and a weight display column 550 displaying requirement items selected by the product seller among the respective requirement items displayed on the basic item display column 510 and the additional item display column 520.

Particularly, through the price as producing cost of the promotional video, the promotional period representing the number of promotional days of the promotional video to be produced, and the profit distribution ratio representing a ratio of distributing a profit generated through showing of the promotional video to a contents creator belonging to the corresponding country which are inserted in the basic item display column 510 provided on the request product purchase option guide screen 500, the contents creators can immediately grape the production intention of the promotional video of the product seller requesting the promotional video. As a result, the contents producers belonging to the corresponding country to produce the promotional video according to the intention of the product seller adjusts their reflection values to guide the reflection values to the corresponding product seller at a time, thereby providing an advantage of guiding the global promotional video to be produced according to the intention of the product seller at a shorter time.

Accordingly, the product seller-side terminal 100 generates a global video production request product history signal including the video production request product history information consisting of the contents of each basic requirement item displayed in the basic item display column 510, the contents of each additional requirement item displayed in the additional item display column 520, the contents of each basic requirement item, a requirement value of the product seller corresponding to the contents of each additional requirement item, an additional allowable value which is additionally allowed as compared with the seller requirement value of the seller, and the contents of the weight requirement item which is the corresponding requirement item displayed in the weight display column 550, as each information input and displayed on the global video production request product purchase option guide screen 500, and transmits the generated global video production request product history signal to the promotional video linkage server 200.

Meanwhile, as an item reflecting the fashion trend when the product seller recognizes the fashion trend of the promotional video related with the product to be currently sold by the product seller, the additional item display column 520 of the global video production request product purchase option guide screen 500 proposes various fashion trends reflected with the culture or customs of another country as the selling country of the product to be sold by the product seller if the product seller does not recognize the fashion trend to provide a function of guiding a promotional video optimized to the current trend that is prevalent in the selling country of the product. To this end, when the promotional video linkage engine 220 of the global promotional video linkage server 200 extracts country-classified sales type-specific trendy keyword information belonging to the corresponding country to sell the product by matching the country-classified sales type-specific promotional video-related trendy keyword DB 214 in which a product list to be sold in the internet shopping mall of the product name to be sold in another country is classified by countries, a product list classified by counties is stored and managed for each category of sales types again, and a sales type-specific trendy keyword which is extracted through data mining from web pages interposed in a promotional video in which a language of the promotional video related with the product list belonging to the sales type by the corresponding category is output to a language of the corresponding country is stored and managed for each sales type by category and transmits the extracted country-classified sales type-specific trendy keyword information to the product seller-side terminal 100 while being translated to the language of the product seller operating the corresponding product seller-side terminal 100 by operating the translation engine 230, the product seller-side terminal 100 performs functions of controlling to output the transmitted sales type-specific trendy keyword information and display the sales type-specific trendy keyword information selected from the output sales type-specific trendy keyword information in the additional item display column 520.

In addition, the global promotional video linkage server 200 performs controlling to search and collect whether a moving video related with the product corresponding to the global video production request product history is present in the web page including blogs, cafes, and SNS on the internet using the language of the corresponding country to sell the product by operating the product video search engine 240 when the product corresponding to the global video production request product history has no sales type by category belonging to the corresponding country to sell the product in the country-classified sales type-specific promotional video-related trendy keyword DB 214, extract a country-classified sales type-specific trendy keyword which is a keyword interposed equally in the web pages collected through data mining, and transmit the extracted country-classified sales type-specific trendy keyword to the product seller-side terminal 100.

At this time, the global promotional video linkage server 200 controls to transmit the extracted country-classified sales type-specific trendy keyword to the product seller-side terminal 100 while being translated to the language of the product seller operating the corresponding product seller-side terminal 100 by operating the translation engine 230.

In addition, the product video search engine 240 of the global promotional video linkage server 200 performs functions of controlling to store and manage the country-classified sales type-specific trendy keyword extracted through the data mining by counties in the country-classified sales type-specific promotional video-related trendy keyword DB 214, establish category-specific sales types of the product related with the corresponding country-classified sales type-specific trendy keyword, and store and manage the established category-specific sales types together with the product names.

The global promotional video linkage server 200 selects country-classified contents creator-side terminals 300a of the corresponding country belonging to the product sales entry country among the country-classified contents creator-side terminals 300a, 300b, and 300c classified by countries by referring to the product sales entry country name information in the information included in the global product sales history signal of the seller-specific global product sales history information DB 211 with reference to the transmitted global video production inquiry history signal and relay-transmits the global video production request product history signal to the selected country-classified contents creator-side terminals 300a of the corresponding country.

In addition, the country-classified contents creator-side terminals 300a, 300b, and 300c of the corresponding country receiving the global video production request product history signal transmit designated-country promotional video production related requirement history signals including the history interposed with the requirements of the contents creator of the corresponding country to the global promotional video linkage server 200, in response to the option required by the product seller included in the global video production request product history.

Here, in order to generate designated-country promotional video production related requirement history signals which are proposal values of the plurality of country-based contents creators according to the requirement of the product seller when producing the promotional video based on the global video production request product history signal, on the display unit of the plurality of country-classified contents creator-side terminals 300, a global video production request product purchase corresponding proposal screen 600 is output to perform a function of guiding various kinds of information included in the aforementioned designated-country promotional video production related requirement history signals to be created.

The global video production request product purchase corresponding proposal screen 600 for performing such a function includes a requirement item display column 610 displaying basic requirement items and additional requirement items required by the product seller, a seller requirement value display column 620 displaying a requirement value of the product seller corresponding to each requirement item displayed on the requirement item display column 610, and a creator proposal value display column 630 displaying a proposal value proposed by the content creator with respect to the requirement value of each requirement item displayed on the seller requirement value display column 620.

Here, the basic requirement items of the product seller displayed on the requirement item display column 610 includes a price as producing cost of the promotional video, a promotional period representing the number of promotional days of the promotional video to be produced, and a profit distribution ratio representing a ratio of distributing a profit generated through showing of the promotional video to a contents creator.

As a result, the designated-country promotional video production related requirement history signal includes promotional video production related requirement information made of the proposal value proposed by the contents creator in response to the requirement value of each requirement item displayed on the seller requirement value display column 620.

In addition, the promotional video linkage engine 220 of the global promotional video linkage server 200 guides the transmitted designated-country promotional video production related requirement history signals to the product seller-side terminal 100.

At this time, the promotional video linkage engine 220 of the global promotional video linkage server 200 calculates each value forming the proposal value information exceeding the requirement value information (having a larger value) among the transmitted designated-country promotional video production related requirement history signals as a percentage, calculates the requirement value displayed on the seller requirement value display column 620 in the information included in the global video production request product history signal as ‘100’, and then calculates the requirement value as a creator-side excess percentage that is the percentage averaging the sum values.

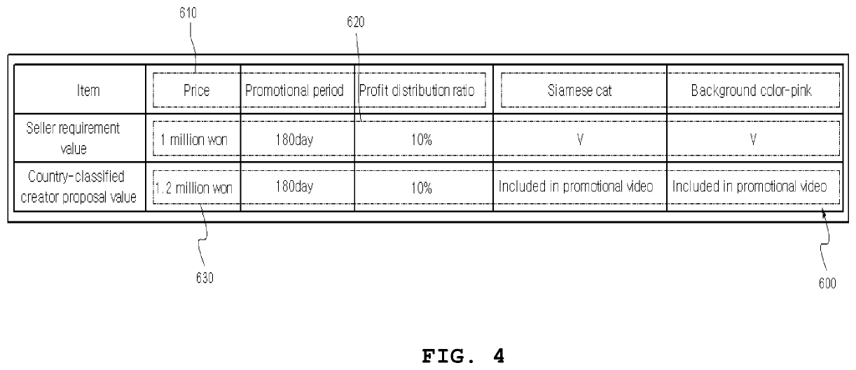

Here, the fact that the requirement value is exceeded or a larger value means that the seller's requirement value is 1 million won when the price displayed in the requirement item display column 610 is shown by mainly referring to FIG. 4, and the proposed value of the contents creator is 1.2 million won, in which the contents creator proposes more than 2 hundred thousand won (or a larger value).

Further, when the price displayed in the requirement item display column 610 is shown, the creator-side excess percentage may confirm that the seller's requirement value is 1 million won and the proposed value of the contents creator is 1.2 million won, which is exceeded by 20% of the seller's requirement value.

Meanwhile, in the case of the profit distribution ratio displayed on the requirement item display column 610, the seller's requirement value and the creator's requirement value are the same as each other, but if the creator's proposal value is 11% which is larger than the seller's requirement value by 1%, the percentage is further proposed by 10% and the creator-side excess percentage of a total of 15% is calculated by summing and averaging the values.

Thereafter, the promotional video linkage engine 220 of the global promotional video linkage server 200 sets the requirement value displayed in the seller requirement value display column 620 of the information included in the global video production request product history signal as ‘100’, calculates a value added by an additional allowable value, and then compares additional allowable percentage information, which is the percentage summing and averaging the values, and the creator-side excess percentage.

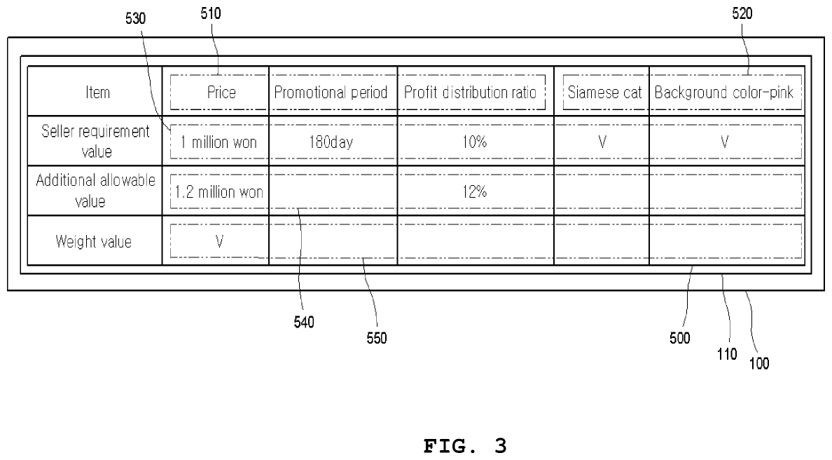

At this time, referring mainly to FIG. 3, in the case of the price displayed on the basic item display column 510, the seller's requirement value is 1 million won and the additional allowable value is 1.2 million won, which is additionally allowed by 20%, and the profit distribution ratio is additionally allowed by 20% from 10% to 12%, and 20% obtained by summing and averaging the values finally becomes an additional allowable percentage.

Thereafter, the promotional video linkage engine 220 of the global promotional video linkage server 200 extracts creator-side excess percentage information belonging to additional allowable percentage information (having a smaller or equal value) when comparing the additional allowable percentage information with the creator-side excess percentage, and selects only the additional allowable proposal value information as the proposal value information corresponding to the creator-side excess percentage belonging to the requirement values of the seller requirement value display column 530 required by the product seller in the case of remaining requirement items except for the weight requirement item which is the corresponding requirement item displayed on the weight display column 550 of the information included in the global video production request product history signal in the proposal value information corresponding to the extracted creator-side excess percentage.

Thereafter, the promotional video linkage engine 220 of the global promotional video linkage server 200 generates an additional allowable designated-country promotional video production related requirement history signal including trend-based promotional video number information counting the number of promotional videos in which the exposure number exceeds the trend-based exposure number in the promotional video produced by the corresponding contents creator having the selected additional allowable proposal value information, the selected additional allowable proposal value information, and identification information on the contents creator proposing the selected additional allowable proposal value information, by matching the selected additional allowable proposal value information with the country-classified creator-specific promotional video production history information DB 213.

Thereafter, the promotional video linkage engine 220 of the global promotional video linkage server 200 controls the generated seller requirement accepted designated-country promotional video production related requirement history signal and the additional allowable designated-country promotional video production related requirement history signal which are included in the designated-country promotional video production related requirement history signal to be transmitted to the product seller-side terminal 100.

At this time, the promotional video linkage engine 220 of the global promotional video linkage server 200 transmits a URL of the promotional video produced by the corresponding country-classified contents creator included in the seller requirement accepted designated-country promotional video production related requirement history signal and the additional allowable designated-country promotional video production related requirement history signal so as to view the promotional video produced by the country-classified contents creator, and guides the corresponding promotional video to be output by linking when the product seller clicks the desired country-classified contents creator to provide the promotional video to be viewed by the product seller.

The product seller-side terminal 100 controls a country-classified creator list screen 700 to be output through the display unit 110, in which the country-classified creator list screen 700 includes a seller requirement accepted country-classified creator list unit 710 displayed so that the product seller may recognize the corresponding country-classified contents creator with respect to a portion where the proposal value proposed by the plurality of country-classified contents creators with regard to the production of the promotional video accepts the requirement value of each requirement item required by the product seller based on each information included in the transmitted designated-country promotional video production related requirement history signals and a seller additional allowable country-based creator list unit 720 displayed so that the product seller may recognize the corresponding country-classified contents creator included in the additional allowable proposal value of the product seller in a list where the proposal value proposed by the plurality of country-classified contents creators with regard to the production of the promotional video exceeds the requirement value of each requirement item required by the product seller.

Here, the seller requirement accepted country-classified creator list unit 710 of the country-classified creator list screen 700 output through the display unit 110 of the product seller-side terminal 100 displays a country-classified creator identifier line 711 identifying creators accepting the requirement value of each requirement item required by the product seller with regard to the production of the promotional video and a trend-based global promotional video number display line 712 displaying the number of promotional videos where the exposure number exceeds the trend-based exposure number in the promotional videos produced by the creators accepting the requirement value of each requirement item required by the product seller with regard to the production of the promotional video. The seller additional allowable country-based creator list unit 720 displays an additional country-classified creator identifier line 721 identifying the corresponding creators included in the additional allowable proposal value of the product seller in the list where the proposal value proposed by the plurality of country-classified contents creators exceeds the requirement value of each requirement item required by the product seller, an additional trend-based global promotional video number display line 722 displaying the number of promotional videos where the exposure number exceeds the trend-based exposure number in the promotional videos produced by the corresponding creators included in the additional allowable proposal value of the product seller in the list where the proposal value proposed by the plurality of country-classified contents creators exceeds the requirement value of each requirement item required by the product seller, and a percentage display line 723 displaying a creator-side excess percentage and an additional allowable percentage.

The product seller-side terminal 100 browsing this notifies the corresponding country-classified contents creator-side terminal 300 selected from the country-classified contents creator-side terminals proposing the designated-country promotional video production related requirement history signals to the global promotional video linkage server 200.

The promotional video linkage engine 220 of the global promotional video linkage server 200 recognizes the corresponding country-classified contents creator-side terminal notified from the product seller-side terminal 100 and notifies the request of the promotional video to the recognized corresponding country-classified contents creator-side terminals 300a, 300b, and 300c using various means such as a short message (SMS), an instant message (IM), a mail, or interposition on the homepage operated by the global promotional video linkage server 200.

Thereafter, the country-classified contents creator-side terminals 300a, 300b, and 300c transmits to the global promotional video linkage server 200 country-specific designated creator-side product promotional video information which is a global promotional video of the corresponding product produced by the request of the global promotional video notified from the global promotional video linkage server 200.

The promotional video linkage engine 220 of the global promotional video linkage server exposes the country-specific designated creator-side product promotional video information transmitted from the corresponding country-classified contents creator-side terminals 300a, 300b, and 300c and the product sales history information of the corresponding product to the internet shopping malls.

Thereafter, the promotional video linkage engine 220 of the global promotional video linkage server 200 counts the viewing number when the customer-side terminal 400 accessing the internet shopping mall views the country-specific designated creator-side product promotional video information interposed in the shopping mall of the customer-side terminal 400 and accumulatively stores promotional product exposure number information which is the viewing number of the counted country-specific designated creator-side product promotional video information in the country-classified creator-specific promotional video production history information DB 213 to guide the product seller to refer to the information when requesting the production of the promotional video according to the his own intention.

What is claimed is:

1. A promotional video production linkage system for sales products classified by countries comprising:
a product seller-side terminal (100) which uploads a global product sales history signal including product sales entry country name information indicating the selling country of the product to be sold and product sales history information as contents related to the sales of the product to be sold;
country-classified contents creator-side terminals (300a), (300b), and (300c) which are classified by countries and produces creator-side product promotional video information which is a promotional video of the corresponding product produced based on product sales history information of a product requested from another country; and
a global promotional video linkage server (200) which includes a promotional video linkage engine (220) which stores and manages a global product sales history signal uploaded from the product seller-side terminal (100) in a seller-specific global product sales history information DB (211),
wherein the promotional video linkage engine (220) of the global promotional video linkage server (200) transmits a global video production inquiry history signal inquiring whether to produce the global promotional video to the language of the corresponding country corresponding to the product sales entry country name information to the product seller-side terminal (100) when there is no promotional information in the product sales history information of the product sales entry country name information and the product sales history information included in the uploaded global product sales history signal,
the product seller-side terminal (100) receives the global video production inquiry history signal, accepts the global promotional video production by the product seller based on the transmitted global video production inquiry history signal, and transmits the global video production request product history signal including an option requested by the product seller at the time of producing the global promotional video as the input information to the global promotional video linkage server (200),
the global promotional video linkage server (200) selects country-classified contents creator-side terminals (300a) of the corresponding country belonging to the product sales entry country among the country-classified contents creator-side terminals (300a), (300b), and (300c) classified by countries by referring to the product sales entry country name information in the information included in the global product sales history signal with reference to the transmitted global video production inquiry history signal and relay-transmits the global video production request product history signal to the selected country-classified contents creator-side terminals (300a) of the corresponding country,
the country-classified contents creator-side terminals of the corresponding country receiving the global video production request product history signal transmit designated-country promotional video production related requirement history signals including the history interposed with the requirements of the contents creator of the corresponding country to the global promotional video linkage server (200), in response to the option required by the product seller included in the global video production request product history,
the promotional video linkage engine (220) of the global promotional video linkage server (200) guides the transmitted designated-country promotional video production related requirement history signals to the product seller-side terminal (100),
the product seller-side terminal (100) notifies the corresponding country-classified contents creator-side terminal (300a), (300b), or (300c) selected from the country-classified contents creator-side terminals (300a), (300b), and (300c) proposing the designated-country promotional video production related requirement history signals to the global promotional video linkage server (200),
the promotional video linkage engine (220) of the global promotional video linkage server (200) recognizes the corresponding country-classified contents creator-side terminal notified from the product seller-side terminal (100) and notifies the request of the promotional video to the recognized corresponding country-classified contents creator-side terminals,
the country-classified contents creator-side terminal transmits to the global promotional video linkage server (200) country-specific designated creator-side product promotional video information which is a global promotional video of the corresponding product produced by the request of the global promotional video notified from the global promotional video linkage server (200), and
the promotional video linkage engine (220) of the global promotional video linkage server exposes the country-specific designated creator-side product promotional video information transmitted from the corresponding country-classified contents creator-side terminals and the product sales history information of the corresponding product to the internet shopping malls.

2. The promotional video production linkage system for sales products classified by countries of claim 1, wherein the global promotional video linkage server (200) includes a translation engine (230); and
the global promotional video linkage server (200) operates the translation engine (230) to control the product sales history information of the corresponding product to be exposed to the internet shopping mall to be exposed while being translated to a language of the sales country of the product to be sold.

3. The promotional video production linkage system for sales products classified by countries of claim 1, further comprising:
a global video production request product purchase option guide screen (500) which includes a basic item display column (510) which displays basic requirement items required basically when producing the promotional video and includes a price as producing cost of the promotional video, a promotional period representing the number of promotional days of the promotional video to be produced, and a profit distribution ratio representing a ratio of distributing a profit generated through showing of the promotional video to a contents creator as information output from the product seller-side terminal (100) accepting the production of the global promotional video based on the transmitted global video production inquiry history signal; and a seller requirement value display column (530) displaying the requirement value of the product seller corresponding to each requirement item displayed in the basic item display column (510).

4. The promotional video production linkage system for sales products classified by countries of claim 3, wherein the global video production request product purchase option guide screen (500) includes an additional item display column (520) displaying additional requirement items which are items required additionally by the product seller when producing the promotional video.

5. The promotional video production linkage system for sales products classified by countries of claim 4, wherein the global promotional video linkage server (200) includes a DB unit (210),
the DB unit (210) includes a country-classified sales type-specific promotional video-related trendy keyword DB (214) in which a product list to be sold in the shopping mall is classified by countries, a product list classified by counties is stored and managed for each category of sales types again, and a sales type-specific trendy keyword which is extracted through data mining from web pages interposed in a promotional video in which a language of the promotional video related with the product list belonging to the sales type by the corresponding category is output to a language of the corresponding country is stored and managed for each sales type by category; and
the promotional video linkage engine (220) of the global promotional video linkage server (200) extracts country-classified sales type-specific trendy keyword information related with the corresponding product among sales types belonging to the sales entry country of the corresponding product by matching the product corresponding to the global video production request product history with the country-classified sales type-specific promotional video-related trendy keyword DB (214) and transmits the extracted country-classified sales type-specific trendy keyword information related with the corresponding product to the product seller-side terminal (100), and
the product seller-side terminal (100) controls to output the transmitted country-classified sales type-specific trendy keyword information and display the country-classified sales type-specific trendy keyword information selected from the output country-classified sales type-specific trendy keyword information in the additional item display column (520).

6. The promotional video production linkage system for sales products classified by countries of claim 5, wherein the global promotional video linkage server (200) includes a product video search engine (240); and
the global promotional video linkage server (200) controls to search and collect whether a moving video related with the product corresponding to the global video production request product history is present in the web page including blogs, cafes, and SNS on the internet using the language of the corresponding country to sell the product by operating the product video search engine (240) when the product corresponding to the global video production request product history has no sales type by category belonging to the corresponding country to sell the product in the country-classified sales type-specific promotional video-related trendy keyword DB (214), extract a country-classified sales type-specific trendy keyword which is a keyword interposed equally in the web pages collected through data mining, and transmit the extracted country-classified sales type-specific trendy keyword to the product seller-side terminal (100) while being translated to the language of the product seller operating the corresponding product seller-side terminal (100) by operating the translation engine (230).

7. The promotional video production linkage system for sales products classified by countries of claim 6, wherein the product video search engine (240) of the global promotional video linkage server (200) controls to store and manage the country-classified sales type-specific trendy keyword extracted through the data mining by counties in the country-classified sales type-specific promotional video-related trendy keyword DB (214), establish category-specific sales types of the product related with the corresponding country-classified sales type-specific trendy keyword, and store and manage the established category-specific sales types together with the product names.

8. The promotional video production linkage system for sales products classified by countries of claim 3, wherein the global video production request product purchase option guide screen (500) includes an additional item display column (520) displaying additional requirement items which are items required additionally by the product seller when producing the promotional video; an additional allowable value display column (540) displaying an allowable value additionally allowed compared with the seller requirement value of the seller as information input by the request of the product seller among the respective requirement items displayed on the seller requirement value display column (530); and a weight display column (550) displaying requirement items selected by the product seller among the respective requirement items displayed on the basic item display column (510) and the additional item display column (520).

9. The promotional video production linkage system for sales products classified by countries of claim 8, wherein the global video production request product history signal, as information displayed on the global video production request product purchase option guide screen (500), includes global video production request product history information consisting of the contents of each basic requirement item displayed in the basic item display column (510), the contents of each additional requirement item displayed in the additional item display column (520), the contents of each basic requirement item, a requirement value of the product seller corresponding to the contents of each additional requirement item, an additional allowable value which is additionally allowed as compared with the seller requirement value of the seller, and the contents of the weight requirement item which is the corresponding requirement item displayed in the weight display column (550).

10. The promotional video production linkage system for sales products classified by countries of claim 9, wherein the designated-country promotional video production related requirement history signal includes promotional video production related requirement information consisting of the proposal value proposed by the country-classified contents creator belonging to the country to sell the corresponding product in response to the requirement value of each requirement item displayed on the seller requirement value display column (620).

11. The promotional video production linkage system for sales products classified by countries of claim 10, wherein the promotional video linkage engine (220) of the global promotional video linkage server (200) extracts proposal value information belonging to the requirement value information compared with the requirement value information of the product seller corresponding to the contents of each basic requirement item and the contents of each additional requirement item in the information in which the proposal value information proposed by the country-classified contents creator is included in the global video production request product history signal in response to the requirement value of each requirement item displayed on the seller requirement value display column (620) in the information included in the transmitted designated-country promotional video production related request history signal when the designated-country promotional video production related request history signals are transmitted, and generates an seller requirement accepted designated-country promotional video production related requirement history signal including trend-based promotional video number information counting the number of promotional videos in which the exposure number exceeds the trend-based exposure number in the promotional videos produced by the corresponding country-classified contents creator having the extracted proposal value information, the extracted proposal value information, and identification information on the country-classified contents creator proposing the extracted proposal value information, by matching the extracted proposal value information with the country-classified creator-specific promotional video production history information DB (213).

12. The promotional video production linkage system for sales products classified by countries of claim 11, wherein the promotional video linkage engine (220) of the global promotional video linkage server (200) calculates each value forming the proposal value information exceeding the requirement value information among the transmitted designated-country promotional video production related requirement history signals as a percentage, calculates the requirement value displayed on the seller requirement value display column (620) in the information included in the global video production request product history signal as ‘100’, and then calculates the requirement value as a creator-side excess percentage that is the percentage averaging the sum values, sets the requirement value displayed in the seller requirement value display column (620) of the information included in the global video production request product history signal as ‘100’, calculates a value added by an additional allowable value, and then compares additional allowable percentage information, which is the percentage summing and averaging the values, and the creator-side excess percentage to extract creator-side excess percentage information belonging to additional allowable percentage information, selects only the additional allowable proposal value information as the proposal value information corresponding to the creator-side excess percentage belonging to the requirement values of the seller requirement value display column (620) required by the product seller in the case of remaining requirement items except for the weight requirement item which is the corresponding requirement item displayed on the weight display column (550) of the information included in the global video production request product history signal in the proposal value information corresponding to the extracted creator-side excess percentage, generates an additional allowable designated-country promotional video production related requirement history signal including trend-based promotional video number information counting the number of promotional videos in which the exposure number exceeds the trend-based exposure number in the promotional video produced by the corresponding contents creator having the selected additional allowable proposal value information, the selected additional allowable proposal value information, and identification information on the contents creator proposing the selected additional allowable proposal value information, by matching the selected additional allowable proposal value information with the country-classified creator-specific promotional video production history information DB (213), and controls the generated seller requirement accepted designated-country promotional video production related requirement history signal and the additional allowable designated-country promotional video production related requirement history signal to be transmitted, which are included in the designated-country promotional video production related requirement history signal while being translated to the language of the product seller operating the corresponding product seller-side terminal 100 by operating the translation engine (230).

13. The promotional video production linkage system for sales products classified by countries of claim 12, further comprising:
a country-classified creator list screen (700) consisting of a seller requirement accepted creator list unit (710) displayed so that the product seller may recognize the corresponding country-classified contents creator with respect to a portion where the proposal value proposed by the plurality of country-classified contents creators with regard to the production of the promotional video accepts the requirement value of each requirement item required by the product seller, as information output to the product seller-side terminal (100) based on the transmitted designated-country promotional video production related requirement history signals; and a seller additional allowable creator list unit (720) displayed so that the product seller may recognize the corresponding creator included in the additional allowable proposal value of the product seller in a list where the proposal value proposed by the plurality of country-classified contents creators with regard to the production of the promotional video exceeds the requirement value of each requirement item required by the product seller.

14. The promotional video production linkage system for sales products classified by countries of claim 13, wherein the seller requirement accepted country-classified creator list unit (710) includes a country-classified creator identifier line (711) identifying country-classified creators accepting the requirement value of each requirement item required by the product seller with regard to the production of the global promotional video and a trend-based global promotional video number display line (712) displaying the number of promotional videos where the exposure number exceeds the trend-based exposure number in the promotional videos produced by the country-classified creators accepting the requirement value of each requirement item required by the product seller with regard to the production of the global promotional video, and
the seller additional allowable country-based creator list unit (720) includes an additional country-classified creator identifier line (721) identifying the corresponding country-classified creators included in the additional allowable proposal value of the product seller in the list where the proposal value proposed by the plurality of country-classified contents creators exceeds the requirement value of each requirement item required by the product seller; an additional trend-based global promotional video number display line (722) displaying the number of promotional videos where the exposure number exceeds the trend-based exposure number in the promotional videos produced by the corresponding country-classified creators included in the additional allowable proposal value of the product seller in the list where the proposal value proposed by the plurality of country-classified contents creators exceeds the requirement value of each requirement item required by the product seller, and a percentage display line (723) displaying a creator-side excess percentage and an additional allowable percentage.

15. The promotional video production linkage system for sales products classified by countries of claim 1, wherein the promotional video linkage engine (220) of the global promotional video linkage server (200) counts the viewing number when the customer-side terminal accessing the internet shopping mall views the country-specific designated creator-side product promotional video information interposed in the internet shopping mall and accumulatively stores promotional product exposure number information which is the viewing number of the counted country-specific designated creator-side product promotional video information in the country-classified creator-specific promotional video production history information DB (213).
